(19) United States
(12) Patent Application Publication
(10) Pub. No.: US 2024/0267194 A1
(43) Pub. Date: Aug. 8, 2024

(54) USER EQUIPMENT (UE) FULL-DUPLEX OPERATION

(71) Applicant: QUALCOMM Incorporated, San Diego, CA (US)

(72) Inventors: Ahmed Elshafie, San Diego, CA (US); Seyedkianoush Hosseini, San Diego, CA (US); Muhammad Sayed Khairy Abdelghaffar, San Jose, CA (US); Krishna Kiran Mukkavilli, San Diego, CA (US)

(21) Appl. No.: 18/166,063

(22) Filed: Feb. 8, 2023

(51) Int. Cl. H04L 5/14; H04L 5/00; H04W 72/044; H04W 72/25; H04W 72/541; H04W 72/543

(52) U.S. Cl. CPC H04L 5/14; H04L 5/0073; H04W 72/0473; H04W 72/25; H04W 72/541; H04W 72/543

(57) ABSTRACT

This disclosure provides systems, methods, and devices for wireless communication that support user equipment (UE) operation, such as UE full-duplex operation. In a first aspect, a method of wireless communication includes, based on self-interference being greater than or equal to a threshold during sidelink (SL) communication and air interface (Uu) communication, performing an interference cancellation operation on one of a SL of the SL communication or a Uu link of the Uu communication, and dropping the other of the SL or the Uu link. Other aspects and features are also claimed and described.

### TECHNICAL FIELD

Aspects of the present disclosure relate generally to wireless communication systems, and more particularly, to UE operation, such as UE full-duplex operation. Some features may enable and provide improved communications, including reduced control overhead, reduced interference, efficient resource utilization, improved sidelink communication, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

With the introduction of 5^{th} Generation (5G) or new radio (NR) networks (sometimes referred to as “5G NR” networks/systems/devices), UEs are able to have higher capability, higher data rate, higher bandwidth. Additionally, UEs are also able to operate in a variety of architectures that provide dual connectivity. For example, one or more devices may support sub band full-duplex (SBFD) operation in which one or more slots are either dynamically or semi-statically signaled as SBFD slots. As devices continue to improve and “do more”, networks and devices of the network may experience increased network congestion, overhead, and interferences associated with air interface (Uu) communication and sideline (SL) communication, such as when multiple devices are densely co-located.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a user equipment (UE). The method includes, based on self-interference being greater than or equal to a threshold during sidelink (SL) communication and air interface (Uu) communication, performing an interference cancellation operation on one of a SL of the SL communication or a Uu link of the Uu communication. The method also includes, based on the self-interference being greater than or equal to the threshold during the SL communication and the Uu communication, dropping the other of the SL or the Uu link.

In an additional aspect of the disclosure, an apparatus includes at least one processor and a memory coupled to the at least one processor. The at least one processor is configured to, based on self-interference being greater than or equal to a threshold during SL communication and Uu communication, perform an interference cancellation operation on one of a SL of the SL communication or a Uu link of the Uu communication. The at least one processor is further configured to, based on the self-interference being greater than or equal to the threshold during the SL communication and the Uu communication, drop the other of the SL or the Uu link.

In an additional aspect of the disclosure, an apparatus includes means for performing, based on self-interference being greater than or equal to a threshold during SL communication and Uu communication, an interference cancellation operation on one of a SL of the SL communication or a Uu link of the Uu communication. The apparatus further includes means for dropping, based on the self-interference being greater than or equal to the threshold during the SL communication and the Uu communication, the other of the SL or the Uu link.

In an additional aspect of the disclosure, a non-transitory computer-readable medium stores instructions that, when executed by a processor, cause the processor to perform operations. The operations include performing, based on self-interference being greater than or equal to a threshold during SL communication and Uu communication, an interference cancellation operation on one of a SL of the SL communication or a Uu link of the Uu communication. The operations further include dropping, based on the self-interference being greater than or equal to the threshold during the SL communication and the Uu communication, the other of the SL or the Uu link.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports UE operation according to one or more aspects.

FIG. 5 is a block diagram illustrating an example of sub-band full-duplex (SBFD) that supports UE operation according to one or more aspects.

FIG. 6 is a block diagram illustrating an example of an air interface (Uu) link and a sidelink (SL) that supports UE operation according to one or more aspects.

FIG. 7 is a block diagram illustrating an example mini-slot that supports UE operation according to one or more aspects.

FIG. 8 is a block diagram illustrating an example Uu link and SL that supports UE operation according to one or more aspects.

FIG. 9 is a block diagram illustrating an example system that supports UE operation according to one or more aspects.

FIG. 10 is a block diagram illustrating an example signaling of SL resources that supports UE operation according to one or more aspects.

FIG. 11 is a block diagram illustrating an example of SL resources that supports UE operation according to one or more aspects.

FIG. 12 is a block diagram illustrating another example of SL resources that supports UE operation according to one or more aspects.

FIG. 13 is a flow diagram illustrating an example process that supports UE operation according to one or more aspects.

FIG. 14 is a block diagram of an example UE that supports UE operation according to one or more aspects.

FIG. 15 is a flow diagram illustrating an example process that supports UE operation according to one or more aspects.

FIG. 16 is a block diagram of an example base station that supports UE operation according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support UE operation. For example, the present disclosure describes UE operation, such as UE full-duplex operations, UE sidelink (SL) operations, and UE full-duplex SL operations. To illustrate, in some aspects, a UE may prioritize between full-duplex air interface (Uu) operation and full-duplex SL operations. For example, the UE may drop an SL link or a Uu link based on an amount of self-interference, and may perform interference cancellation on the non-dropped link. In some aspects, the UE may be configured to use a mini-slot SL format, such as mini-slot format 2. For example, a direction of communication between the UE and another UE may be determined and shared via SL control information (SCI). In some aspects, the UE may use a per Uu subband time division duplex (TDD) pattern that is configured to support SL communication-e.g., avoid interference. In some aspects, the UE may share, with a base station, information associated with a SL, such as full-duplex resources, to enable the base station to allocate one or more SL resources. Additionally, or alternatively, a Tx UE may provide SCI that indicates resources used by the Tx UE. In some implementations, a reference signal received power (RSRP) threshold or a channel sensing parameter may be adjusted based on whether a UE is using full-duplex or half-duplex on a Uu link or an SL link.

Particular implementations of the subject matter described in this disclosure may be implemented to realize one or more of the following potential advantages or benefits. In some aspects, the present disclosure provides techniques for supporting UE operation, such as UE full-duplex operation. For example, the techniques described enable improved communication through efficient use of full-duplex communications, self-interference cancellation, or a combination thereof. As another example, some features may enable and provide improved communications, including reduced control overhead, improved transmit power management, efficient resource utilization, improved sidelink communication, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc.

In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies.

Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

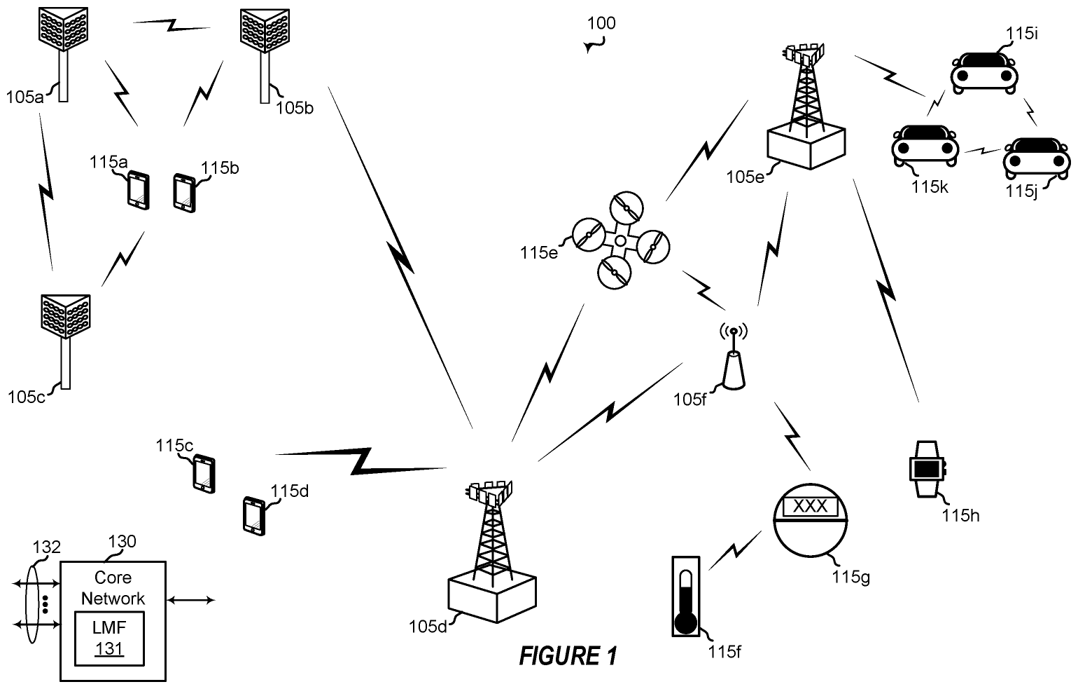

FIG. 1 is a block diagram illustrating details of an example wireless communication system according to one or more aspects. The wireless communication system may include wireless network 100. Wireless network 100 may for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF) 131, which is an entity in the 5G Core Network (5GC) supporting various functionality, such as managing support for different location services for one or more UEs. For example the LMF 131 may include one or more servers, such as multiple distributed servers. Base stations 105 may forward location messages to the LMF 131 and may communicate with the LMF via a NR Positioning Protocol A (NRPPa). The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via an Access and Mobility Management Function (AMF).

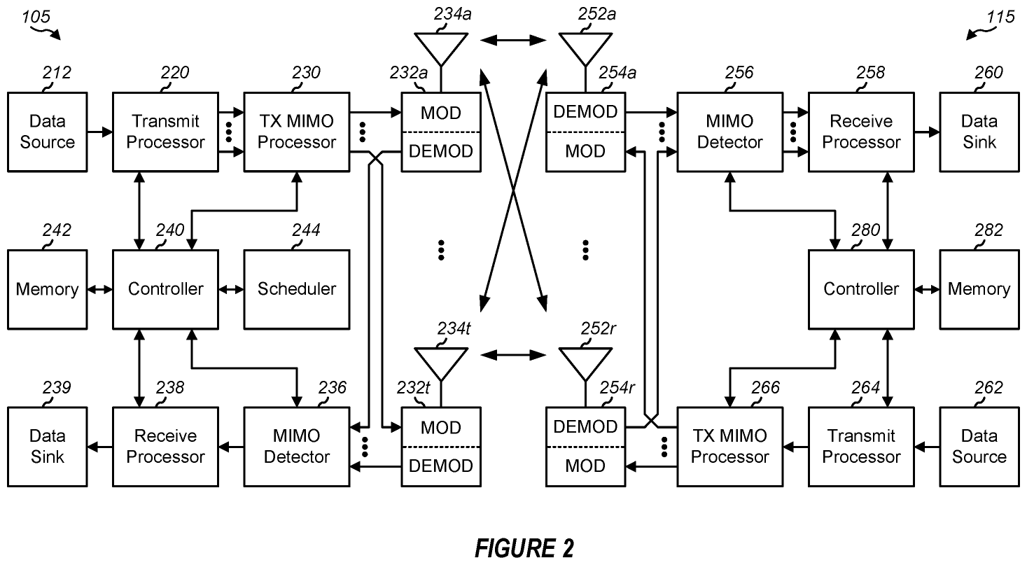

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

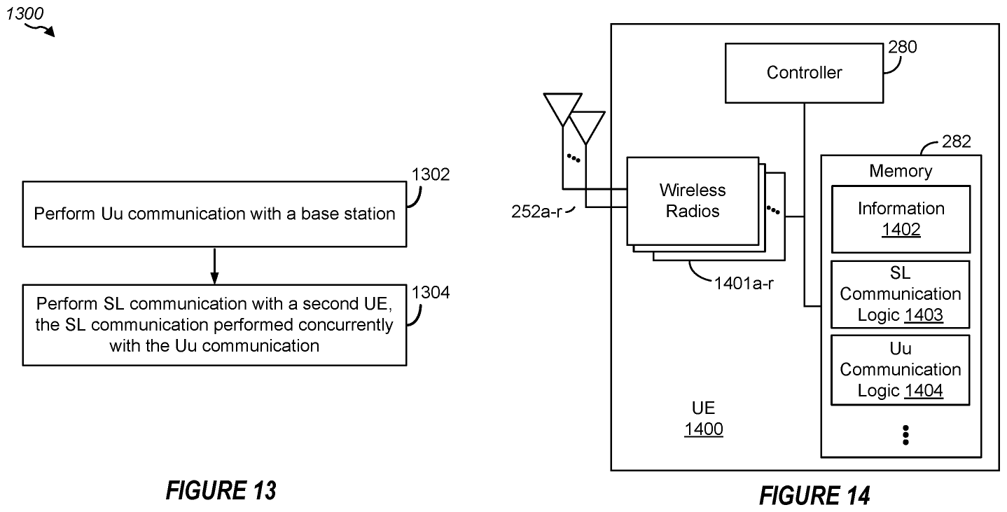

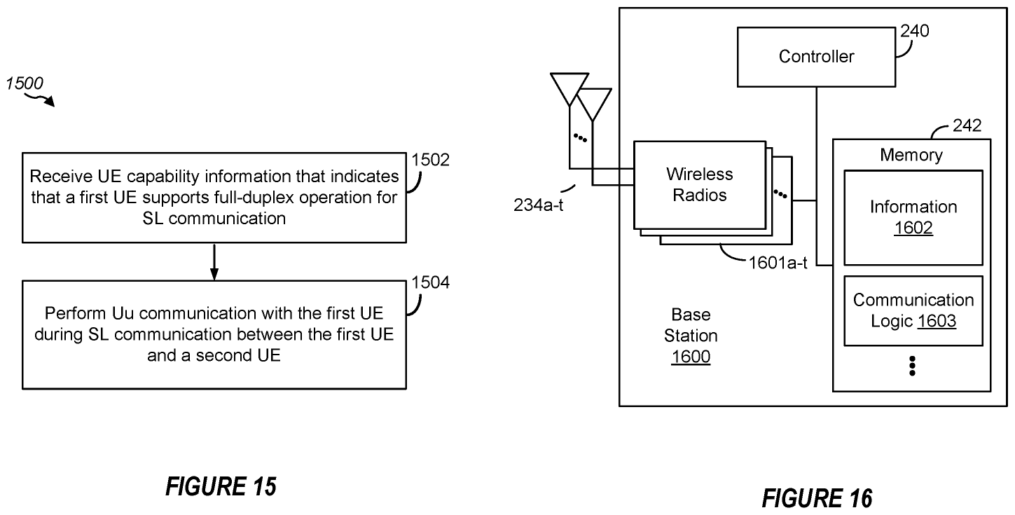

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in FIGS. 13 and 15, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

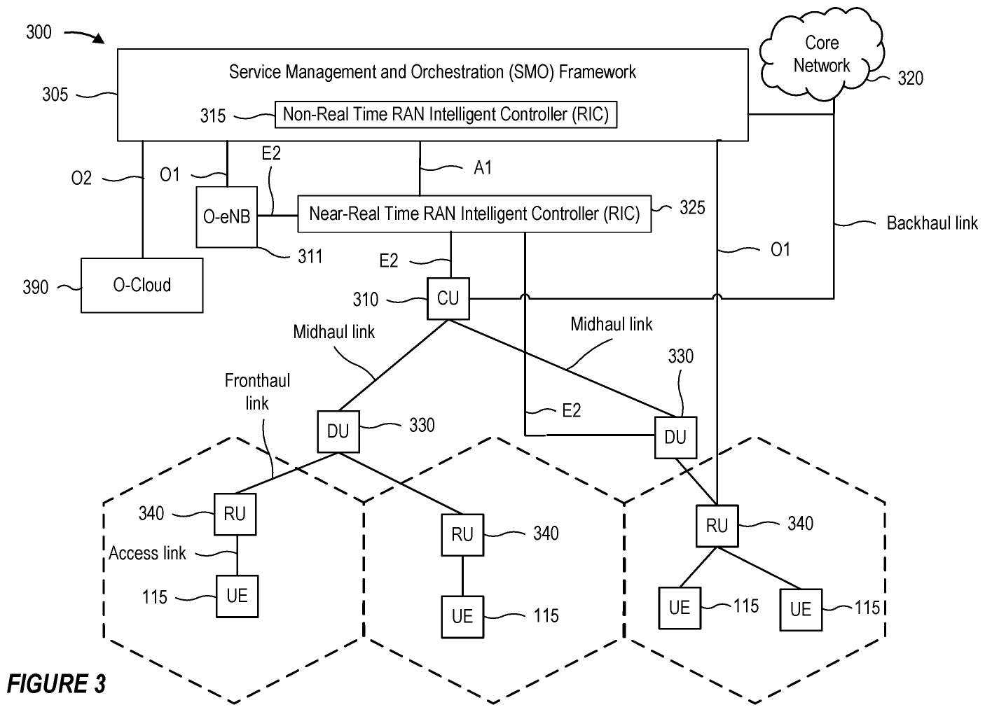

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service

Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 115. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the

Near-RT RIC 325 may be configured to tune RAN behavior or performance. For example, the Non-RT RIC 315 may monitor long-term trends and patterns for performance and employ AI/ML models to perform corrective actions through the SMO

Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

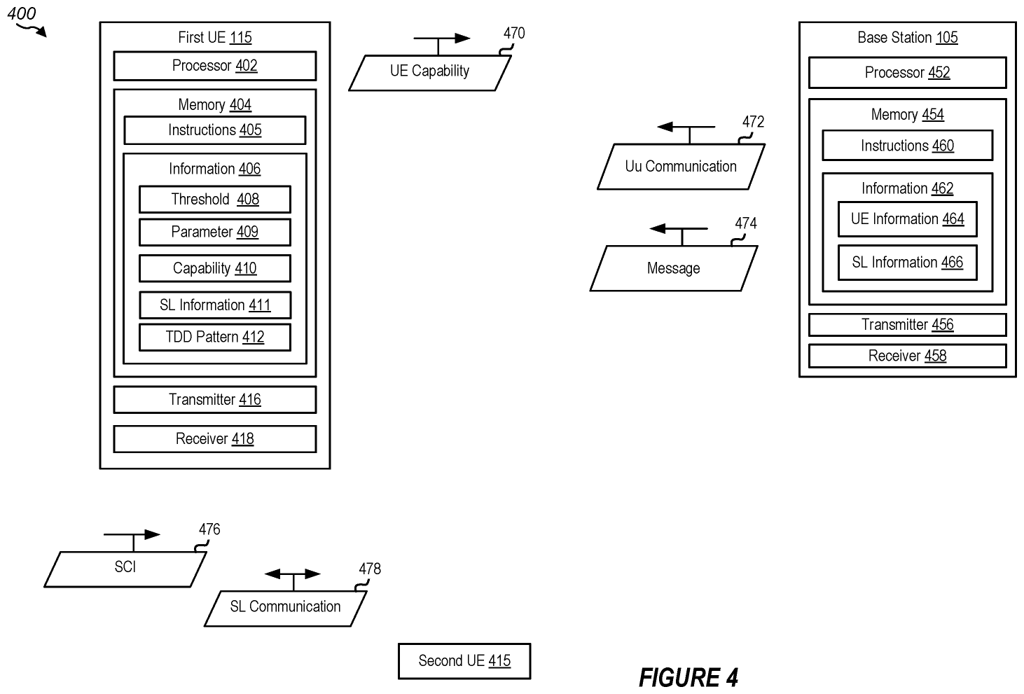

FIG. 4 is a block diagram of an example wireless communications system 400 that supports UE operation according to one or more aspects. In some examples, wireless communications system 400 may implement aspects of wireless network 100. Wireless communications system 400 includes UE 115, a UE 415, and base station 105. Although two UEs 115 and one base stations, in some other implementations, wireless communications system 400 may include a different number of UEs, a different number of base stations, or a combination thereof.

UE 115 may be configured to perform Uu communication, SL communication, or a combination thereof. UE 115 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 416 (hereinafter referred to collectively as “transmitter 416”), and one or more receivers 418 (hereinafter referred to collectively as “receiver 418”). In some implementations, UE 115 may include an interface (e.g., a communication interface) that includes transmitter 416, receiver 418, or a combination thereof. Processor 402 may be configured to execute instructions 405 stored in memory 404 to perform the operations described herein. In some implementations, processor 402 includes or corresponds to one or more of receive processor 258, transmit processor 264, and controller 280, and memory 404 includes or corresponds to memory 282.

Memory 404 includes or is configured to store instructions 405 and information 406. The information 406 may include a threshold 408, a parameter 409, a capability 410, SL information 411, and a TDD pattern 412. In some implementations, information 406 may include or indicate one or more measurements, such as a self-interference measurement or an RSRP measurement, as illustrative, non-limiting examples.

Threshold 408 may include or indicate one or more thresholds. For example, threshold 408 may include or correspond to an interference threshold, such as a self-interference threshold. Additionally, or alternatively, threshold 408 may include or correspond to a reference signal received power (RSRP) threshold.

Parameter 409 may include or indicate one or more parameters. In some implementations, at least one parameter of parameter 409 is defined by a standard. Parameter 409 may include or indicate a priority, a gap, a transmit power, or a mode. Additionally, or alternatively, the one or more parameters may include a quality of service, a number sub-slots in an SL slot, a mode of operation of the UE, a remaining PDB, or a combination thereof. The priority may include or indicate a priority of traffic communicated via the SL, a priority of traffic communicated via the Uu link, or a combination thereof. The gap may include or indicate a gap between a Tx subband and an Rx subband associated with the SL communication, or a gap between a Tx sub-resource pool and an Rx sub-resource pool associated with the SL communication. The transmit power may include or indicate a transmit power for the SL communication, a transmit power for the Uu communication, or a combination thereof. The mode may include or indicate an RA mode, such as mode 1 RA or mode 2 RA. The quality of service may include or indicate a quality of service of traffic communicated via the SL, a quality of service of traffic communicated via the Uu link, or a combination thereof. The number of sub-slots may include or indicate a number of full-duplex sub-slots in a SL slot, a number of half-duplex sub-slots in the SL slot, or a combination thereof. In some implementations, parameter 409 may include a channel sensing parameter. For example, the channel sensing parameter include a first sensing window parameter (T₀), a second sensing window parameter (T_{2,min}) or a combination thereof.

Capability 410 may include or indicate one or more capabilities of first UE 115. For example, capability 410 may include or indicate whether or not first UE 115 supports full-duplex operation, whether or not first UE 115 supports SL communication, a number transmitters for SL communication, a number of receivers for SL communication, or a combination thereof.

SL information 411 may include or indicate a resource pool or resource pool information, usage information (that indicates a resource of the resource pool), sub-band full-duplex (SBFD) operation or in-band full-duplex (IBFD) operation, a min-slot format (e.g., a first format-format 1, or a second format-format 2), a slot communication direct (Tx only, Rx only, or full-duplex), a number of full-duplex sub-slots in an SL slot or a resource for the full-plex sub-slots, a number of half-duplex sub-slots in the SL slot or a resource for the half-duplex sub-slots, a first set of sub-slots for transmission by first UE 115, a second set of sub-slots for transmission by second UE 41, a third set of sub-slots for full-duplex transmission, a remaining PDB, SCI, a priority of traffic to be transmitted via the SL, an SL grant, whether first UE 115 or second UE 415 is configured to concurrently receive two RX communications with discontinuous resource blocks (RBs), a frequency domain resource allocation (FDRA), or a combination thereof. In some implementations, SL information 411 includes threshold 408, parameter 409, capability 410, TDD pattern 412, or a combination thereof.

TDD pattern 412 may include or indicate one or more TDD patterns. For example, TDD pattern 412 may include or indicate a first TDD (e.g., a first TDD pattern), a second TDD (e.g., a second TDD pattern), or a combination thereof. In some implementations, TDD pattern 412 may be common TDD pattern that is common to one or more UEs, or may be a dedicated TDD pattern that is specific to first UE 115. In some implementations, TDD pattern 412 may be associated with or correspond to a sub-band.

Transmitter 416 is configured to transmit reference signals, control information and data to one or more other devices, and receiver 418 is configured to receive references signals, synchronization signals, control information and data from one or more other devices. For example, transmitter 416 may transmit signaling, control information and data to, and receiver 418 may receive signaling, control information and data from, base station 105. In some implementations, transmitter 416 and receiver 418 may be integrated in one or more transceivers. Additionally or alternatively, transmitter 416 or receiver 418 may include or correspond to one or more components of UE 115 described with reference to FIG. 2.

In some implementations, UE 115 may include one or more antenna arrays. The one or more antenna arrays may be coupled to transmitter 416, receiver 418, or a communication interface. The antenna array may include multiple antenna elements configured to perform wireless communications with other devices, such as with the base station 105. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the UE 115. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

UE 415 may include one or more components as described herein with reference to UE 115. Additionally, UE 415 may be configured to perform one or more operations as described herein with reference to UE 115.

UE 115 or 415 may include one or more components as described herein with reference to UE 115. In some implementations, UE 115 is a 5G-capable UE, a 6G-capable UE, or a combination thereof.

Base station 105 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, base station 105 may include an interface (e.g., a communication interface) that includes transmitter 456, receiver 458, or a combination thereof. Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242.

Memory 454 includes or is configured to store instructions 460 and information 462. The information 406 may include Uu information 464 and SL information 466. Uu information 464 may include or correspond to one or more parameters or settings to enable or support Uu communication 472. In some implementations, Uu information 464 may include or correspond to threshold 408, parameter 409, capability 410, TDD pattern 412, or a combination thereof. SL information 411 may include or correspond to SL information 411.

Transmitter 456 is configured to transmit reference signals, synchronization signals, control information and data to one or more other devices, and receiver 458 is configured to receive reference signals, control information and data from one or more other devices. For example, transmitter 456 may transmit signaling, control information and data to, and receiver 458 may receive signaling, control information and data from, UE 115. In some implementations, transmitter 456 and receiver 458 may be integrated in one or more transceivers. Additionally or alternatively, transmitter 456 or receiver 458 may include or correspond to one or more components of base station 105 described with reference to FIG. 2 or one or more components of disaggregated base station 300.

In some implementations, base station 105 may include one or more antenna arrays. The one or more antenna arrays may be coupled to transmitter 456, receiver 458, or a communication interface. The antenna array may include multiple antenna elements configured to perform wireless communications with other devices, such as with the UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of the base station 105. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

In some implementations, wireless communications system 400 implements a 5G NR network. For example, wireless communications system 400 may include multiple 5G-capable UEs 115 and multiple 5G-capable base stations 105, such as UEs and base stations configured to operate in accordance with a 5G NR network protocol such as that defined by the 3GPP. In some other implementations, wireless communications system 400 implements a 6G network.

During operation of wireless communications system 400, first UE 115 transmits UE capability 470. UE capability 470 may include or indicate information 406, threshold 408, parameter 409, capability 410, SL information 411, TDD pattern 412, or a combination thereof. In some implementations, UE capability 470 indicates that first UE 115 supports full-duplex operation.

In some implementations, base station 105 may receive UE capability 470. Based on UE capability 470, base station 105 may allocate a resource pool for use by first UE 115. For example, base station 105 may allocate the resource pool based on first UE 115 being able to support full-duplex operation. The resource pool may indicate or define one or more time resource, one or more frequency resources, or a combination thereof. For example, the resource may include or indicate a resource pool for SL communication during SBFD operation or IBFD. The minimum transmission/reception (e.g., allocation) unit in time may be a subchannel, and each subchannel may be defined as a number of continuous RBs. A resource pool can be further configured with one of multiple resource allocation modes. For example, the multiple resource allocation modes may include a first resource allocation mode and a second resource allocation mode. The first resource allocation mode may include a mode 1 RA in which base station 105 is configured to assign resources for SL transmission and both dynamic allocation via DCI format 3-x and configured transmissions (both Type-1 and Type-2) are supported. The second resource allocation mode may include mode 2 RA in which first UE 115 is configured to sense one or more resources and, based on an outcome of the sensing (e.g., priority of different transmissions, RSRP, or both), first UE 115 selects one or more resources for its transmission. In some implementations, the resource pool includes a maximum power constraint on first UE 115.

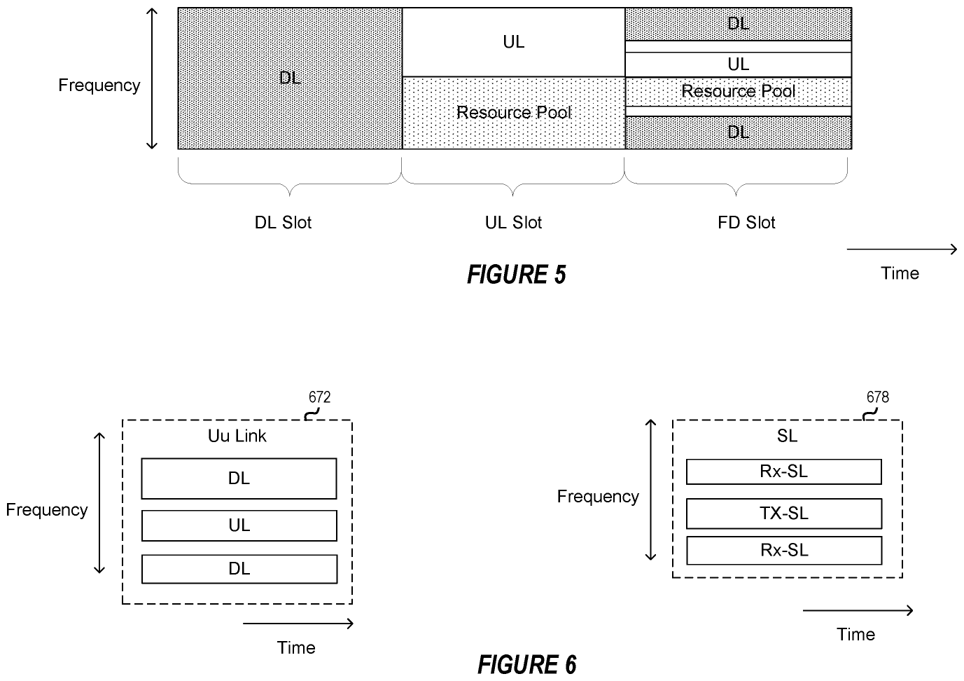

Referring to FIG. 5, FIG. 5 is a block diagram illustrating an example of SBFD that supports UE operation according to one or more aspects. For example, the UE operation may include NR operations and SL operations performed on the same carrier. In some implementations the carrier is included in a licensed spectrum.

As shown, multiple slots include a DL slot, a UL slot, and a full-duplex (FD) slot. The DL slot is associated with DL Uu communication and the UL slot is associated with UL Uu communication. The FD slot is associate with full-duplex Uu communication that includes a first DL resource (e.g., a band), a UL resource, and a second DL resource. The first DL resource may be separated (e.g., in the frequency domain) from the UL resource by a first gap. The second DL resource may be separated (e.g., in the frequency domain) from the UL resource by a second gap.

Base station 105 may support SBFD and some slots (e.g., the UL slot or the FD slot) may be dynamically or semi-statically signaled as SBFD slots. Additionally, a portion of the UL slot and a portion of the FD slot (e.g., the UL resource) may be allocated for SL communication and included in a resource pool (e.g., a SL resource pool) that is indicated to first UE 115. It is noted, that allocation of a portion of UL resources to the resource pool (for SL communication) results in a smaller UL portion and a full UL slot. It is noted that the SL resource pool may be defined within a UL portion of the slots, a change in bandwidth (BW) of a UL portion may impact how a UE performs resource selection or reservation. In some implementations, SBFD slots can be signaled via a common RRC configuration, e.g., by SIB, and can be UE specific, could be indicated dynamically, or a combination thereof.

Referring back to FIG. 4, base station 105 may transmit, to first UE 115, an indicator that indicates the allocated resource pool. In some implementations, the indicator may include or be included in radio resource control (RRC) or a medium access control-control element (MAC-CE). Additionally, or alternatively, indicator may include or indicate one or more parameters such as parameter 409. Additionally, or alternatively, the indicator may include slot direction information for one or more sub-slots of a slot for SL communication. To illustrate, the slot direction information may indicate half-duplex communication or full-duplex communication. In some implementations, the indicator indicates an RSRP threshold, such as threshold 408.

Base station 105 and first UE 115 may perform Uu communication 472 between base station 105 and first UE 115. For example, Uu communication 472 may occur via a Uu link. Uu communication 472 may include half-duplex communication or full-duplex communication. Uu communication 472 may include first UE 115 transmitting one or more Uu communications to base station 105, base station 105 transmitting one or more Uu communications to first UE 115, or a combination thereof.

First UE 115 may establish a SL communication session with second UE 415. For example, to establish or during the SL communication session, first UE 115 may transmit SCI 476 to second UE 415. In some implementations, first UE 115 may transmit one or more SCI (e.g., 476) associated with multiple Tx-SL. In some implementations, the one or more SCI may include, for each Tx-SL of the multiple Tx-SL, an SCI that indicates a resource allocated of the Tx-SL. In some other implementations, the one or more SCI may include, a single SCI that indicates, for each Rx UE associated with the SL communication, a FDRA of a Tx-SL resource set of the Rx UE. Additionally, or alternatively, SCI 476 may include or indicate slot direction information for SL communication between first UE 115 and second UE 415, half-duplex SL communication or full-duplex SL communication, an RSRP threshold, or a combination thereof. In some implementations, SCI 476 may include or indicate, for a slot for SL communication between first UE 115 and second UE 415, a first set of sub-slots for transmission by first UE 115, a second set of sub-slots for transmission by second UE 415, a third set of sub-slots for full-duplex transmission, half-duplex resources for a first set of sub-slots, full-duplex resources for a second set of sub-slots, or a combination thereof.

First UE 115 and second UE 415 may perform SL communication 478 between first UE 115 and second UE 415 during the SL communication session. For example, SL communication 478 may occur via an SL. SL communication 478 may include half-duplex communication or full-duplex communication. SL communication 478 may include first UE 115 transmitting one or more SL communications to second UE 415, second UE 415 transmitting one or more SL communications to first UE 115, or a combination thereof. In some implementations, traffic of the SL communication includes ultra-reliable low latency communications (URLLC) traffic or extended reality (XR) traffic. The XR traffic may include virtual reality (VR) traffic, mixed reality (MR) traffic, or augmented reality (AR) traffic, as illustrative, non-limiting examples.

First UE 115 may perform Uu communication (e.g., 472) concurrently with SL communication (e.g., 478). To illustrate, first UE 115 may configured first UE 115 for concurrent full-duplex SL communication and full-duplex Uu communication, as an illustrative, non-limiting example. In some implementations, base station 105 may transmit a message 474 (e.g., data or information) to first UE 115. Message 474 may include or indicate information associated with the SL communication. For example, message 474 may include or indicate threshold 408, parameter 409, SL information 411, TDD pattern 412, or a combination thereof. In some implementations, message 474 may include or indicate a change indicator or an SL grant. The change indicator may indicate to change a TDD pattern from a first TDD to a second TDD for use during the Uu communication, the SL communication, or both. The first TDD may include a dedicated TDD pattern or a common TDD pattern. In some implementations, the TDD pattern is a per sub-band dedicated TDD pattern in which the per sub-band dedicated TDD pattern is configured such that a first sub-band that overlaps with the SL has more UL slots than a second sub-band that does not overlap with the SL. In some implementations, such as when first UE 115 is configured for a mode 1 RA, the SL grant may include one or more configured grants (CGs) associated with one or more Rx UEs (of the SL communication session), or one or more dynamic grants (DGs) associated with the one or more Rx UEs. At least one Rx UE of the one or more Rx UEs may be configured to concurrently receive two Rx communications with discontinuous RBs. In some implementations, a grant received from base station 105 via a Uu link may include or indicate RSRP information, such as an RSRP threshold (e.g., 408).

In some implementations, first UE 115 may transmit information to base station 105. For example, the information may include usage information or SL information. The usage information may include or indicate a resource of the allocated resource pool to be allocated. The SL information may include or indicate a TDD pattern for the SL communication, usage of a resource pool, a gap between a Tx resource and an Rx resource, or a combination thereof. Additionally, or alternatively, the sideline information may include or indicate, for the SL communication between first UE 115 and second UE 415, a first number of Rx resources that first UE 115 is configured to concurrently monitor, a second number of Rx resources that second UE 415 is configured to concurrently monitor, or a combination thereof.

In some implementations, first UE 115 may be configured to prioritize communication between the Uu link and the SL under full-duplex. To illustrate, first UE 115 may receive parameter 409, one or more rules, or threshold 408 that are defined by a standard or included or indicated in RRC or a MAC-CE. For example, first UE 115 may prioritize communication between the Uu link and the SL when first UE 115 is configured for full-duplex on both the SL and the Uu link. Being configured for full-duplex on both the SL link and Uu link may produce high self-interference and cancellation has to be directed to one signal, unless first UE 115 is capable of cancellation of both signals simultaneously using two circuits.

Referring to FIG. 6, FIG. 6 is a block diagram illustrating an example of a Uu link 672 and an SL 678 that supports UE operation according to one or more aspects. Uu link 672 may include or correspond to Uu communication 472. SL 678 may include or correspond to SL corresponding to SL communication 478. Uu link 672 may include one or more DL resources, one or more UL resources, or a combination thereof.

As shown, Uu link 672 includes a first DL resource (e.g., a band), a UL resource, and a second DL resource. The first DL resource may be separated (e.g., in the frequency domain) from the UL resource by a first gap. The second DL resource may be separated (e.g., in the frequency domain) from the UL resource by a second gap.

As shown, SL 678 includes a first Rx-SL resource (e.g., a band), a Tx-SL resource, and a second Rx-SL resource. The first Rx-SL resource may be separated (e.g., in the frequency domain) from the Tx-SL resource by a first gap. The second Rx-SL resource may be separated (e.g., in the frequency domain) from the Tx-SL resource by a second gap.

First UE 115 may be configured to drop, either partially or fully, the Uu link or the SL. For example, first UE 115 may drop the Uu link or the SL based on threshold 408, parameter 409, or the one or more rules. To illustrate, for the SL, first UE 115 may drop a Tx-SL, an Rx-SL, or both a Tx-SL and an Rx-SL, and for the Uu link, first UE 115 may drop a DL, a UL, or both a DL and a UL. In some implementations, first UE 115 may drop, either partially or fully, the Uu link or the SL based on priority, gap between DL and UL and gap between Tx and Rx subbands/subRPs on sidelink, transmit power on sidelink and on Uu link (high power in Uu link could mean that Rx at SL is useless), or RA mode (1 or 2). It is noted that mode 1 RA after receiving a DL grant could mean that the DL grant is being canceled if UE behavior is not expected to be full duplex both the Uu link and the SL.

In some implementations, a resource pool may include or indicate a maximum power constraint, such as a maximum transmit power level or threshold, for one or more UEs (e.g., 115 or 415). The maximum power constraint may be associated with enabling a UE to use sidelink DL slots under SBFD or IBFD. In some implementations, base station 105 may limit allocate of frequency resources to only UEs configured for full-duplex. To illustrate, base station 105 may indicate mode 1 RA operation so that base station 105 to control interference by UEs is controlled. In some implementations, an indication of the mode 1 RA operation may include or correspond to a dynamic indication of usage.

Referring back to FIG. 4, in some implementations, first UE 115 determines self-interference at first UE 115. For example, first UE 115 may determine the self-interference during SL communication, Uu communication, or both SL and Uu communication. For example, first UE 115 may detect self-interference greater than or equal to a threshold during full duplex SL communication and full duplex Uu communication. Based on the self-interference being greater than or equal to a threshold, first UE may perform an interference cancellation operation on one of a SL of the SL communication or a Uu link of the Uu communication. For example, first UE may select, based on parameter 409, the one of the SL or the Uu link for the interference cancellation operation. Additionally, or alternatively, based on the self-interference being greater than or equal to a threshold, first UE may drop the other of the SL or the Uu link. Dropping the SL link may include dropping a Tx SL, an Rx SL, or both. Dropping the Uu link may include dropped an uplink (UL), a downlink (DL), or both.

In some implementations, SL communication 478 may include a min-slot SL (e.g., a mini-slot format, such as a first mini-slot format or a second mini-slot format). A slot that is split into multiple sub-slots, where each sub-slot has PSCCH, PSSCH or both. Additionally, each sub-slot may be self-schedulable and decodable. A UE, such as first UE 115 or second UE 415, may select and reserve one or multiple sub-slot per slot. As the number of sub-slots increases per slot (which enhances scheduling latency and is suitable for small packets, e.g., 32B for IIOT), additional symbols may be allocated to gaps. It is noted that gap symbols may only needed for Tx/Rx switching, such as at the end of a slot.

In some implementations, a slot may split into multiple sub-slots according to a given pattern (e.g., the pattern may indicate a length for each subslot and the number of subslots per slot). Additionally, or alternatively, SL SCI1/PSCCH may be positioned at the beginning of each slot. The SL SCI can indicate a transmission/reservation of a number of subslots in the same or future slots. In some implementations, AGC symbols may not be needed since the receiver can set the AGC based on the first symbol of the slot and use the same setting for the reception of any of the PSSCH subslots.

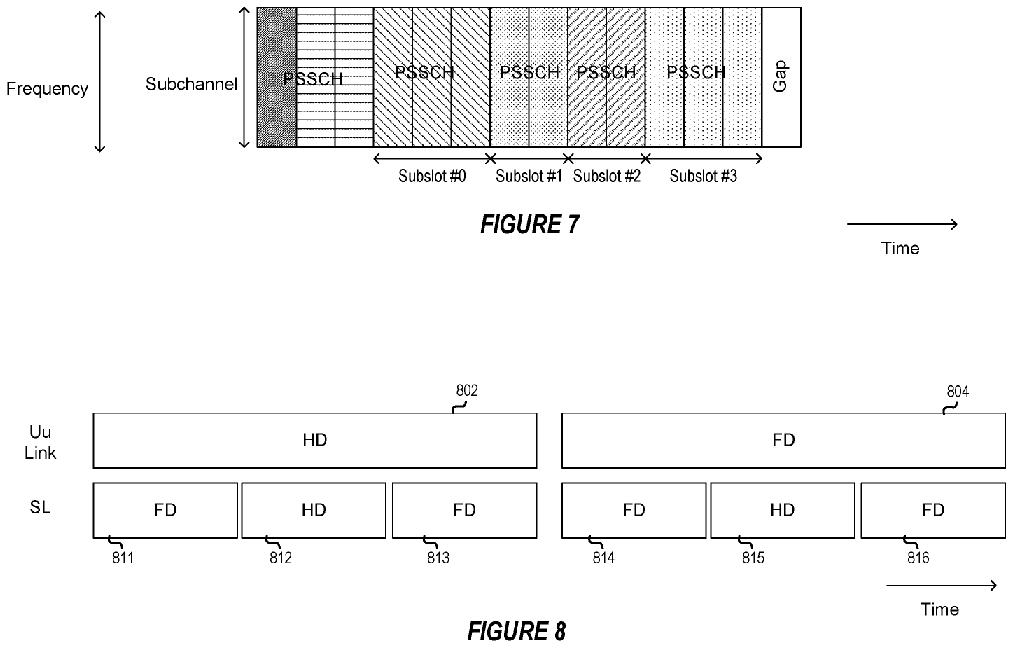

Referring to FIG. 7, FIG. 7 is a block diagram illustrating an example mini-slot that supports UE operation according to one or more aspects. As shown, a slot is partitioned into multiple sub-slots. One or more sub-slots may be grouped for a physical sidelink shared channel (PSSCH). Although, as For example, a first group of sub-slots (subslot #0) includes three sub-slots, a second group of sub-slots (subslot #1) includes two sub-slots, a third group of sub-slots (subslot #2) includes two sub-slots, and a fourth group of sub-slots (subslot #4) includes three subslots. It is noted that the mini-slot format shown in FIG. 7 is a mini-slot format 2, and that other formats are possible.

In some implementations, with a direction of SL communication may be indicated for the SL communication. The direction may be indicated by base station 105 or by a UE (e.g., 115 or 415). It is noted that for a SL communication session, one UE (e.g., an initiating UE) may be referred to as a Tx UE and the other UE may be referred to as an Rx UE. For example, a slot direction or sub-slot direction may be indicated for a mini-slot. The direction may include a Tx direction or an Rx direction. In some implementations, the direction may include Tx only, Rx only, or Tx and RX (e.g., full-duplex). It is noted that the Tx direction or the Rx direction may be indicated with respect to the Tx UE.

In some implementations, selecting or dropping a Uu link or a SL mini-slot may be based on parameter 409 or one or more rules. For example, selecting or dropping the Uu link or the SL mini-slot may be based on priority/QoS, how many FD and HD mini-slots are included in a SL slot, a mode of operation, remaining PDB, or a combination thereof.

Referring to FIG. 8, FIG. 8 is a block diagram illustrating an example Uu link and SL that supports UE operation according to one or more aspects. As shown, six slots are shown. The Uu link includes a half-duplex portion 802 for three slots and a full-duplex portion 804 for three slots. The SL includes full-duplex portions 811, 813, 814, and 816, and half-duplex portions 812 and 815.

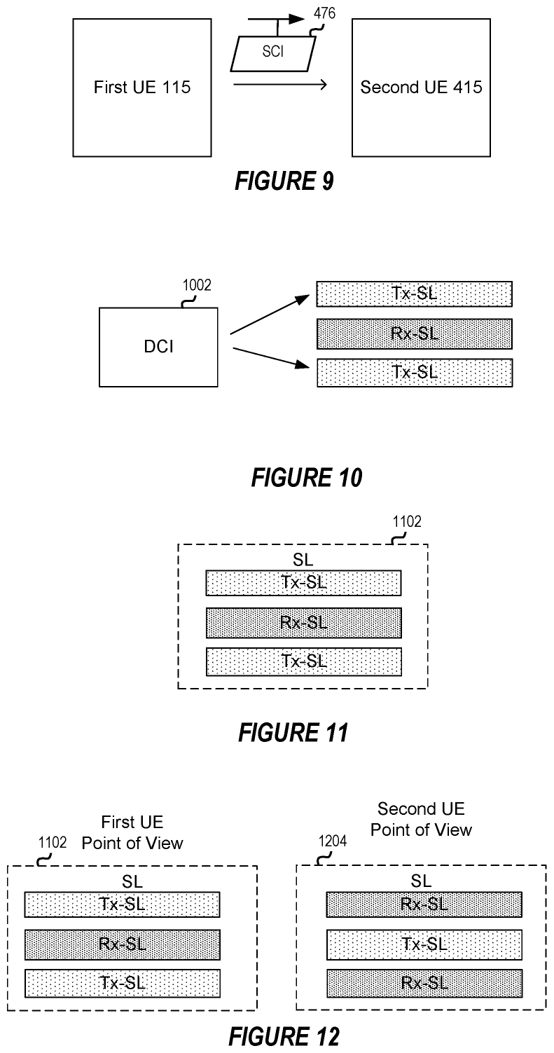

Referring back to FIG. 4, the first UE 115 (e.g., a Tx UE) and the second UE 415 (e.g., an Rx UE) may determine one or more directions based on their data priorities and remaining PDB. For example, referring to FIG. 9, FIG. 9 is a block diagram illustrating an example system that supports UE operation according to one or more aspects. As shown in FIG. 9, first UE 115 transmits SCI 476 to second UE 415. SCI 476 may schedule a set of its mini-slots for its own transmission and another set for the other UE, UE 2 transmission, and a third subset of mini-slots for full-duplex transmission. Such scheduling may be understood as scheduling a set of half-duplex resources and a set of full-duplex resources, such as those shown at least with reference to FIG. 8. In other implementations, base station 105 may schedule the direction of mini-slots, such as half-duplex or full-duplex slots or sub-slots, from first UE 115 to second UE 415, or from second UE 415 to first UE 115. In such implementations, a UE (e.g., first UE 115) may transmit SCI 476 to indicate the direction to one or more other UEs (e.g., 415). For example, referring to FIG. 10, FIG. 10 is a block diagram illustrating an example signaling of SL resources that supports UE operation according to one or more aspects. As shown in FIG. 10, DCI 1002 is transmitted by base station 105 to first UE 115 and assigns grants to first UE 115 per SL subband for first UE 115 configured for full-duplex operation.

Referring to FIG. 11, FIG. 11 is a block diagram illustrating an example of SL 1102 resources that supports UE operation according to one or more aspects. It is noted that the SL 1102 resources may be indicated or allocated by base station 105 using DCI 1002. SL 1102 resources may be understood from the point of view of first UE 115, such as a Tx UE. As shown, SL 1102 includes a first Tx-SL resource (e.g., a band), an Rx-SL resource, and a second Tx-SL resource. The first Tx-SL resource may be separated (e.g., in the frequency domain) from the Rx-SL resource by a first gap. The second Tx-SL resource may be separated (e.g., in the frequency domain) from the Rx-SL resource by a second gap.

Referring to FIG. 12, FIG. 12 is a block diagram illustrating another example of SL 1204 resources that supports UE operation according to one or more aspects. It is noted that the SL 1102 resources may be indicated or allocated by base station 105 using DCI 1002, or determined between first UE 115 and second UE 415 and communicated from first UE 115 to second UE 415 using SCI 476. SL 1204 resources may be understood from the point of view of second UE 415, such as an Rx UE. As shown, SL 1204 includes a first Rx-SL resource (e.g., a band), a Tx-SL resource, and a second Rx-SL resource. The first Rx-SL resource may be separated (e.g., in the frequency domain) from the Tx-SL resource by a first gap. The second Rx-SL resource may be separated (e.g., in the frequency domain) from the Tx-SL resource by a second gap. It is noted that SL 1102 and SL 1204 may correspond to the same SL during the same time period and that the different bands are the same-e.g., first Tx-SL of SL 1102 and first Rx-SL of SL 1204 are the same band.

Referring again to FIG. 4, in some implementations, first UE 115 determines slot direction information for one or more sub-slots of a slot for the SL communication between first UE 115 and second UE 415. For example, first UE 115 may determine the slot direction information based on a remaining PDB (of first UE 115 or second UE 415), or a priority of traffic to be transmitted by first UE 115 via the SL, a priority of traffic to be transmitted by second UE 415 via the SL link, or a combination thereof. A slot communication direction indicated by the slot direction information may include or indicate Tx only, Rx only, or full-duplex.

In some implementations, an RSRP threshold (e.g., 408) may depend whether first UE 115 is using half-duplex or full-duplex on the SL, whether one or more UEs (e.g., 115 or 415) are using half-duplex or full-duplex on the Uu link. Use of half-duplex or full-duplex on the Uu link may be between UEs (e.g., 115 and 415) or indicated to first UE 115 by base station 105. It is noted that a UE may at least know whether the UE communicates on the Uu link based on from one or more grants received by the UE on Uu link. In some implementations, first UE 115 may determine an RSRP threshold (e.g., 408). The RSRP threshold may be determined based on half-duplex communication or full-duplex communication on the SL, half-duplex communication or full-duplex communication on the Uu link, or a combination thereof. In some implementations, first UE 115 may generate the RSRP threshold or first UE 115 may receive, from base station 105, RSRP information that indicates the RSRP threshold.

In some implementations, first UE 115 adjusts the RSRP threshold based on an agreement with second UE 415 associated with the SL communication or base station 105, a scheduled grant or configured grant of the Uu link, a grant associated with the Uu link and that is known to first UE 115, the Uu communication being half-duplex or full-duplex, or a combination thereof. Additionally, or alternatively, first UE 115 may adjust a channel sensing parameter based on a full-duplex status of the SL communication, a full-duplex status of the Uu communication, or a combination thereof. The channel sensing parameter may include a first sensing window parameter (T₀), a second sensing window parameter (T_{2,min}), or a combination thereof. In some implementations, the first sensing window parameter (T₀) may be configured or pre-configured with 100 ms or 1100 ms.

The second sensing window parameter (T_{2,min}) may be configured or pre-configured per priority {1, 5, 10, 20}·2^{μ}, μ=0, 1, 2, 3 for SCS 15, 30, 60, 120 kHz, respectively.

As described with reference to FIG. 4, the present disclosure provides techniques for supporting UE operation, such as UE full-duplex operation. The techniques described enable improved communication through efficient use of full-duplex communications, self-interference cancellation, or a combination thereof. As another example, some features may enable and provide improved communications, including reduced control overhead, improved transmit power management, efficient resource utilization, improved sidelink communication, or a combination thereof

FIG. 13 is a flow diagram illustrating an example process 1300 that supports UE operation according to one or more aspects. Operations of process 1300 may be performed by a UE, such as UE 115 described above with reference to FIGS. 1-4 or a UE described with reference to FIG. 14. For example, example operations (also referred to as “blocks”) of process 1300 may enable UE 115 to support UE operation. In some implementations, the UE may be configured to perform one or more operations as described at least with reference to FIGS. 4-12.

In block 1302, the UE performs Uu communication with a base station. For example, the base station may include or correspond to base station 105. The Uu communication may include or correspond to Uu communication 472.

In block 1304, the UE performs SL communication with another UE. The other UE may include or correspond to second UE 415. The SL communication may include or correspond to SL communication 478. In some implementations, the SL communication performed concurrently with the Uu communication. In some implementations, the UE performs one or more operations to configure the UE for concurrent full duplex SL communication and full duplex Uu communication.

In some implementations, the UE may detect an amount of self-interference. Additionally, or alternatively, the UE may compare the amount of self-interference to a threshold. For example, the threshold may include or correspond to threshold 408. In some implementations, the UE may determine that the self-interference is greater than or equal to a threshold during full duplex SL communication and full duplex Uu communication.

In some implementations, based on the self-interference being greater than or equal to the threshold during the SL communication and the Uu communication, the UE performs an interference cancellation operation on one of a SL of the SL communication or a Uu link of the Uu communication. For example, the UE may select the one of the SL or the Uu link for the interference cancellation operation based on one or more parameters, e.g., a value of a parameter. The one or more parameters may include or correspond to parameter 409. In some implementations, the one or more parameters include a priority, a gap, a transmit power, or a mode. Additionally, or alternatively, the one or more parameters may include a quality of service, a number sub-slots in an SL slot, a mode of operation of the UE, a remaining PDB, or a combination thereof. The priority may include or indicate a priority of traffic communicated via the SL, a priority of traffic communicated via the Uu link, or a combination thereof. The gap may include or indicate a gap between a Tx subband and an Rx subband associated with the SL communication, or a gap between a Tx sub-resource pool and an Rx sub-resource pool associated with the SL communication. The transmit power may include or indicate a transmit power for the SL communication, a transmit power for the Uu communication, or a combination thereof. The mode may include or indicate an RA mode. The quality of service may include or indicate a quality of service of traffic communicated via the SL, a quality of service of traffic communicated via the Uu link, or a combination thereof. The number of sub-slots may include or indicate a number of full-duplex sub-slots in a SL slot, a number of half-duplex sub-slots in the SL slot, or a combination thereof. Additionally, or alternatively, based on the self-interference being greater than or equal to the threshold during the SL communication and the Uu communication, the UE may drop the other of the SL or the Uu link. Dropping the SL link may include droppings a Tx SL, an Rx SL, or both. Alternatively, dropping the Uu link may include dropped a UL, a DL, or both.

In some implementations, the UE transmits UE capability information that indicates that the UE supports full-duplex operation. The UE capability information may include or correspond to capability 410 or UE capability 470. In some implementations, the UE receives, from the base station, resource pool information that indicates a resource pool for the SL communication during SBFD operation or IBFD operation. The base station may allocate the resource pool, such as a resource pool configured for mode 1 RA, for use by the UE based on the UE supporting full-duplex operation. In some implementations, the resource pool includes or indicates a maximum power constraint on the UE, such as a maximum power constraint for the SL communication, half-duplex communication, full-duplex communication, or a combination thereof.

In some implementations, the SL communication includes a mini-slot format. Additionally, or alternatively, a slot communication direction may be defined by the UE or the base station. For example, the slot direction information may include or correspond to SL information 411 or 466, or message 474. The slot communication direction may include or indicate Tx only, Rx only, or full-duplex. In some implementations, the UE receives the slot direction information from the base station. To illustrate, the slot direction information may include or correspond to one or more sub-slots of a slot for the SL communication. Additionally, or alternatively, the slot direction information may indicate half-duplex communication or full-duplex communication. The UE may transmit SCI to another UE, such as the second UE 415. The SCI may include or correspond to SCI 476. The SCI may include or indicate the slot direction information for SL communication between the UE and the other UE.

In some implementations, the UE determines the slot direction information for one or more sub-slots of a slot for the SL communication between the UE and the other UE. For example, the UE may determine the slot direction information based on a remaining PDB, a priority of traffic to be transmitted by the UE via the SL, a priority of traffic to be transmitted by the other UE via the SL link, or a combination thereof. In some implementations, the UE generates the SCI that indicates, for a slot for SL communication between the UE and the other UE, a first set of sub-slots for transmission by the UE, a second set of sub-slots for transmission by the other UE, a third set of sub-slots for full-duplex transmission, or a combination thereof. Additionally, or alternatively, the UE may transmit the SCI to the other UE.

In some implementations, the UE receives, form the base station, a change indicator that indicates to change a TDD pattern from a first TDD to a second TDD for use during the Uu communication, the SL communication, or both. The first TDD, the second TDD, or both, may include or correspond to TDD pattern 412. In some implementations, the first TDD includes a dedicated TTD pattern or a common TDD pattern.

In some implementations, the UE receives a per sub-band dedicated TDD pattern. For example, the per sub-band dedicated TDD pattern may include or correspond to TDD pattern. The per sub-band dedicated TDD pattern may configured such that a first sub-band that overlaps with the SL has more UL slots than a second sub-band that does not overlap with the SL.

In some implementations, the UE receives a SL grant from the base station. The SL grant may include or correspond to message 474. When the UE is configured for a mode 1 RA, the SL grant may include one or more CGs associated with one or more Rx UEs, or one or more DGs associated with the one or more Rx UEs.

In some implementations, the UE transmits, to the base station, SL information that indicates a TDD pattern for the SL communication, usage of a resource pool, a gap between a Tx resource and an Rx resource, or a combination thereof. The SL information may include or correspond to information 406, SL information 411, TDD pattern 412, or a combination thereof. Additionally, or alternatively, the SL information may include or indicate, for the SL communication between the UE and the other UE, a first number of Rx resources that the UE is configured to concurrently monitor, a second number of Rx resources that the other UE is configured to concurrently monitor, or a combination thereof.

In some implementations, the UE transmits one or more SCI associated with multiple Tx-SL. The one or more SCI may include or correspond to SCI 476. The one or more SCI may include or indicate, for each Tx-SL of the multiple Tx-SL, an SCI of the one or more SCI that indicates a resource allocated for the Tx-SL. Alternatively, the one or more SCI may include or indicate a single SCI that indicates, for each Rx UE associated with the SL communication, an FDRA of a Tx-SL resource set of the Rx UE.

In some implementations, the UE determines an RSRP threshold. For example, the RSRP threshold may include or correspond to threshold 408. The RSRP threshold may be based on half-duplex communication or full-duplex communication on the SL, half-duplex communication or full-duplex communication on the Uu link, or a combination thereof. The UE may transmit RSRP information that indicates the RSRP threshold. Additionally, or alternatively, the UE may receive, from the base stations, the RSRP information that indicates the RSRP threshold. For example, the RSRP information may be included in or indicated by message 474.

In some implementations, the UE adjusts the RSRP threshold based on an agreement with the other UE associated with the SL communication or the base station, a scheduled grant or configured grant of the Uu link, a grant associated with the Uu link and that is known to the UE, the Uu communication being half-duplex or full-duplex, or a combination thereof. Additionally, or alternatively, the UE may adjust a channel sensing parameter based on a full-duplex status of the SL communication, a full-duplex status of the Uu communication, or a combination thereof. The channel sensing parameter may include or indicate a first sensing window parameter (T₀), a second sensing window parameter (T_{2,min}), or a combination thereof.

FIG. 14 is a block diagram of an example UE 1400 that supports UE operation according to one or more aspects. UE 1400 may be configured to perform operations, including the blocks of a process described with reference to FIG. 13. In some implementations, UE 1400 includes the structure, hardware, and components shown and described with reference to UE 115 or 415 of FIGS. 1-4. For example, UE 1400 includes controller 280, which operates to execute logic or computer instructions stored in memory 282, as well as controlling the components of UE 1400 that provide the features and functionality of UE 1400. UE 1400, under control of controller 280, transmits and receives signals via wireless radios 1401a-r and antennas 252a-r. Wireless radios 1401a-r include various components and hardware, as illustrated in FIG. 2 for UE 115, including modulator and demodulators 254a-r, MIMO detector 256, receive processor 258, transmit processor 264, and TX MIMO processor 266.

As shown, memory 282 may include information 1402, SL communication logic 1403, Uu communication logic 1404, or a combination thereof. Information 1402 may include or correspond to information 406, threshold 408, parameter 409, capability 410, SL information 411, TDD pattern 412, or a combination thereof. SL communication logic 1403 may be configured to enable UE 1400 to perform one or more SL communication operations with another UE, such as second UE 415. Uu communication logic 1404 may 1404 may be configured to enable UE 1400 to perform one or more Uu communication operation with a network entity, such as a base station, a TRP, a core network, or an LMF. UE 1400 may receive signals from or transmit signals to one or more network entities, such as base station 105 of FIGS. 1-4 or a base station as illustrated in FIG. 16.

FIG. 15 is a flow diagram illustrating an example process 1500 that supports UE operation according to one or more aspects. Operations of process 1500 may be performed by a base station, such as base station 105 described above with reference to FIGS. 1-4 or a base station as described above with reference to FIG. 16. For example, example operations of process 1500 may enable base station 105 to support UE operation.

At block 1502, the base station receives UE capability information that indicates that a first UE supports full-duplex operation for SL communication. For example, the first UE may include or correspond to first UE 115. The UE capability information may include or correspond to capability 410, SL information 466, or UE capability 470.

At block 1504, the base station perform Uu communication with the first UE during SL communication between the first UE and a second UE. The Uu communication may include or correspond to Uu communication 472. The second UE may include or correspond to second UE 415. The SL communication may include or correspond to SL communication 478.

In some implementations, the base station transmits, to the first UE, resource pool information. The resource pool information may include or correspond to SL information 411, SL information 466, or message 474. In some implementations, the resource pool is configured for mode 1 RA. The resource pool information may that indicate or include a resource pool for the SL communication during SBFD operation or IBFD operation. In some implementations, the resource pool includes a maximum power constraint on a UE, such as first UE 115 or second UE 415. Additionally, or alternatively, the base station may allocate the resource pool for use by the UE based on the UE supporting full-duplex operation.

In some implementations, the base station transmits slot direction information for one or more sub-slots of a slot for the SL communication. For example, the slot direction information may include or correspond to SL information 411, SL information 466, or message 474. The slot direction information may indicate half-duplex communication or full-duplex communication.

In some implementations, the base station transmits a change indicator that indicates to the first UE to change a TDD pattern from a first TDD to a second TDD for use during the Uu communication, the SL communication, or both. The first TDD or the second TDD may include or correspond to TDD pattern 412. The change indicator may include or correspond to message 474. In some implementations, the first TDD includes a dedicated TTD pattern or a common TDD pattern.

In some implementations, the base station transmits a SL grant. For example, the SL grant may include or correspond to SL information 411, SL information 466, or message 474. When the first UE is configured for a mode 1 RA, the SL grant may include or indicate one or more CGs associated with one or more Rx UEs. Alternatively, When the first UE is configured for a mode 1 RA, the SL grant may include or indicate one or more DGs associated with the one or more Rx UEs.

In some implementations, the base station receives, from the first US or the second UE, SL information that indicates a TDD pattern for the SL communication, usage of a resource pool, or a gap between a Tx resource and an Rx resource. Additionally, or alternatively, the SL information may indicate, for the SL communication between the first UE and the second UE, a first number of Rx resources that the first UE is configured to concurrently monitor; or a second number of Rx resources that the second UE is configured to concurrently monitor; or a combination thereof.

In some implementations, the base station determines an RSRP threshold. The RSRP may include or correspond to threshold 408. The RSRP may be determined based on half-duplex communication or full-duplex communication on the SL, half-duplex communication or full-duplex communication on the Uu link, or a combination thereof. The base station 105 may transmit RSRP information that indicates the RSRP threshold.

FIG. 16 is a block diagram of an example base station 1600 that supports UE operation according to one or more aspects. Base station 1600 may be configured to perform operations, including the blocks of process 1500 described with reference to FIG. 15. In some implementations, base station 1600 includes the structure, hardware, and components shown and described with reference to base station 105 of FIGS. 1-4. For example, base station 1600 may include controller 240, which operates to execute logic or computer instructions stored in memory 242, as well as controlling the components of base station 1600 that provide the features and functionality of base station 1600. Base station 1600, under control of controller 240, transmits and receives signals via wireless radios 1601a-t and antennas 234a-t. Wireless radios 1601a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include information 1602 and communication logic 1603. Information 1602 may include or correspond to information 462, Uu information 464, SL information 466, or a combination. Communication logic 1603 may be configured to enable communication between base station 1600 and one or more other devices. Base station 1600 may receive signals from or transmit signals to one or more UEs, such as UE 115 or 415 of FIGS. 1-4 or UE 1400 of FIG. 14.

It is noted that one or more blocks (or operations) described with reference to FIGS. 13 and 15 may be combined with one or more blocks (or operations) described with reference to another of the figures. For example, one or more blocks (or operations) of FIG. 13 may be combined with one or more blocks (or operations) of FIG. 15. As another example, one or more blocks associated with FIG. 13 or 15 may be combined with one or more blocks (or operations) associated with FIGS. 1-12. Additionally, or alternatively, one or more operations described above with reference to FIGS. 1-4 may be combined with one or more operations described with reference to FIG. 14 or 16.

In one or more aspects, techniques for supporting UE operation may include additional aspects, such as any single aspect or any combination of aspects described below or in connection with one or more other processes or devices described elsewhere herein. In a first aspect, techniques for supporting UE operation may include performing Uu communication with a base station via a Uu link. The techniques may further include performing SL communication with another UE via a SL. The SL communication is performed concurrently with the Uu communication. In some examples, the techniques in the first aspect may be implemented in a method or process. In some other examples, the techniques of the first aspect may be implemented in a wireless communication device, which may include a UE or a component of a UE. In some examples, the wireless communication device may include at least one processing unit or system (which may include an application processor, a modem or other components) and at least one memory device coupled to the processing unit. The processing unit may be configured to perform operations described herein with respect to the wireless communication device. In some examples, the memory device includes a non-transitory computer-readable medium having program code stored thereon that, when executed by the processing unit, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the techniques further include, based on self-interference being greater than or equal to a threshold during the SL communication and the Uu communication, performing an interference cancellation operation on one of the SL of the SL communication or the Uu link of the Uu communication.

In a third aspect, in combination with the second aspect, the techniques further include, the techniques further include, based on the self-interference being greater than or equal to the threshold during the SL communication and the Uu communication, dropping the other of the SL or the Uu link.

In a fourth aspect, in combination with the second aspect or the third aspect, the self-interference is determined to be greater than or equal to the threshold during full duplex SL communication and full duplex Uu communication.

In a fifth aspect in combination with one or more of the first aspect through the fourth aspect, the techniques further include configuring the UE for concurrent full duplex SL communication and full duplex Uu communication.

In a sixth aspect, in combination with one or more of the first aspect through the fifth aspect, the techniques further include detecting self-interference greater than or equal to a threshold during full duplex SL communication and full duplex Uu communication.

In a seventh aspect, in combination with the second aspect, the techniques further include selecting the one of the SL or the Uu link for the interference cancellation operation.

In an eighth aspect, in combination with the seventh aspect, the one of the SL or the Uu link is selected based on one or more parameters.

In a ninth aspect, in combination with the eighth aspect, the one or more parameters include a priority of traffic communicated via the SL, a priority of traffic communicated via the Uu link, or a combination thereof.

In a tenth aspect, in combination with the eighth aspect or the ninth aspect, the one or more parameters include a gap between a downlink band and an uplink band associated with the Uu communication, a gap between a Tx subband and an Rx subband associated with the SL communication, or a gap between a Tx sub-resource pool and an Rx sub-resource pool associated with the SL communication.

In an eleventh aspect, in combination with one or more of the eighth aspect through the tenth aspect, the one or more parameters include a transmit power for the SL communication, a transmit power for the Uu communication, or a combination thereof.

In a twelfth aspect, in combination with one or more of the eighth aspect through the eleventh aspect, the one or more parameters include an RA mode.

In a thirteenth aspect, in combination with one or more of the third aspect through the twelfth aspect, to drop the SL link, the techniques further include droppings a Tx SL, an Rx SL, or both.

In a fourteenth aspect, in combination with one or more of the third aspect through the twelfth aspect, to drop the Uu link, the techniques further include dropping a UL, a DL, or both.

In a fifteenth aspect, in combination with one or more of the eighth aspect through the twelfth aspect, the one or more parameters are defined by a standard.

In a sixteenth aspect, in combination with one or more of the eighth aspect through the twelfth aspect, or the fifteenth aspect, the techniques further include receiving signaling that indicates the one or more parameters.

In a seventeenth aspect, in combination with the sixteenth aspect, to receive the signaling the techniques further include receiving an RRC or an MAC-CE that indicates the one or more parameters.

In an eighteenth aspect, in combination with one or more of the first aspect through the seventeenth aspect, the techniques further include receiving a resource pool information that indicates resource pool for the SL communication during SBFD operation or IBFD operation. In some implementations of the eighteenth aspect, the resource pool may include a maximum power constraint on a UE.

In a nineteenth aspect, in combination with one or more of the first aspect through the eighteenth aspect, the techniques further include transmitting UE capability information that indicates that the UE supports full-duplex operation.

In a twentieth aspect, in combination with the eighteenth aspect or the nineteenth aspect, the base station allocates the resource pool for use by the UE based on the UE supporting full-duplex operation

In a twenty-first aspect, in combination with the twentieth aspect, the resource pool is configured for mode 1 RA.

In a twenty-second aspect, in combination with one or more of the first aspect through the twenty-first aspect, the techniques further include transmitting usage information to the base station.

In a twenty-third aspect, in combination with the twenty-second aspect, the usage information indicates a resource of the resource pool to be allocated for Uu communication.

In a twenty-fourth aspect, in combination with one or more of the first aspect through the twenty-third aspect, the SL communication includes a mini-slot format.

In a twenty-fifth aspect, in combination with one or more of the first aspect through the twenty-fourth aspect, a slot communication direction is defined by the UE or a base station.

In a twenty-sixth aspect, in combination with the twenty-fifth aspect, the slot communication direction include Tx only, Rx only, or full-duplex.

In a twenty-seventh aspect, in combination with one or more of the eighth aspect through the twenty-sixth aspect, the one or more parameters include a quality of service of traffic communicated via the SL, a quality of service of traffic communicated via the Uu link, or a combination thereof.

In a twenty-eighth aspect, in combination with one or more of the eighth aspect through the twenty-seventh aspect, the one or more parameters include a number of full-duplex sub-slots in a SL slot, a number of half-duplex sub-slots in the SL slot, or a combination thereof.

In a twenty-ninth aspect, in combination with one or more of the eighth aspect through the twenty-eighth aspect, the one or more parameters further include the one or more parameters include a mode of operation of the UE.

In a thirtieth aspect, in combination with one or more of the eighth aspect through the twenty-ninth aspect, the one or more parameters include a remaining PDB.

In a thirty-first aspect, in combination with one or more of the first aspect through the thirtieth aspect, the techniques further include receiving, from a base station, slot direction information for one or more sub-slots of a slot for the SL communication, the slot direction information indicates half-duplex communication or full-duplex communication.

In a thirty-second aspect, in combination with the thirty-first aspect, the techniques further include transmitting SCI to the other UE, the SCI indicates the slot direction information for SL communication between the UE and the other UE.

In a thirty-third aspect, in combination with one or more of the first aspect through the thirty-second aspect, the techniques further include determining slot direction information for one or more sub-slots of a slot for the SL communication between the UE and another UE.

In a thirty-fourth aspect, in combination with the thirty-third aspect, the slot direction information is determined based on a remaining PDB.

In a thirty-fifth aspect, in combination with the thirty-third aspect or the thirty-fourth aspect, the slot direction information is determined based on a priority of traffic to be transmitted by the UE via the SL, a priority of traffic to be transmitted by the other UE via the Uu link, or a combination thereof.

In a thirty-sixth aspect, in combination with one or more of the first aspect through the thirty-fifth aspect, the techniques further include generating SCI that indicates, for a slot for SL communication between the UE and another UE, a first set of sub-slots for transmission by the UE, a second set of sub-slots for transmission by the other UE, a third set of sub-slots for full-duplex transmission, or a combination thereof.

In a thirty-seventh aspect, in combination with the thirty-sixth aspect, the techniques further include transmitting the SCI to the other UE.

In a thirty-eighth aspect, in combination with one or more of the first aspect through the thirty-fifth aspect, the techniques further include generating SCI that indicates, for a slot for the SL communication between the UE and other UE, half-duplex resources for a first set of sub-slots, full-duplex resources for a second set of sub-slots, or a combination thereof.

In a thirty-ninth aspect, in combination with one or more of the first aspect through the thirty-eighth aspect, the techniques further include receiving, from a base station, a change indicator that indicates to change a TDD pattern from a first TDD to a second TDD for use during the Uu communication, the SL communication, or both.

In a fortieth aspect, in combination with the thirty-ninth aspect, the first TDD includes a dedicated TTD pattern or a common TDD patterns.

In a forty-first aspect, in combination with one or more of the first aspect through the fortieth aspect, the techniques further include receiving a per sub-band dedicated TDD pattern. In some aspects, the per sub-band dedicated TDD pattern is configured such that a first sub-band that overlaps with the SL has more UL slots than a second sub-band that does not overlap with the SL.

In a forty-second aspect, in combination with one or more of the first aspect through the forty-first aspect, traffic of the SL communication includes URLLC traffic or XR traffic.

In a forty-third aspect, in combination with one or more of the first aspect through the forty-second aspect, the techniques further include receiving, from a base station, a sidelink grant.

In a forty-fourth aspect, in combination with the forty-third aspect, for the UE configured for a mode 1 RA, the sidelink grant includes one or more CGs associated with one or more Rx UEs.

In a forty-fifth aspect, in combination with the forty-third aspect, for the UE configured for a mode 1 RA, the sidelink grant includes one or more DGs associated with the one or more Rx UEs.

In a forty-sixth aspect, in combination with one or more of the forty-third aspect through the forty-fifth aspect, an Rx UE of the one or more Rx UEs is configured to concurrently receive two Rx communications with discontinuous RBs.

In a forty-seventh aspect, in combination with one or more of the forty-third aspect through the forty-fifth aspect, the techniques further include transmitting, to the base station, sidelink information that indicates a TDD pattern for the SL communication, usage of a resource pool, a gap between a Tx resource and an Rx resource, or a combination thereof

In a forty-eighth aspect, in combination with the forty-seventh aspect, the sidelink information further indicates, for the SL communication between the UE and another UE, a first number of Rx resources that the UE is configured to concurrently monitor, a second number of Rx resources that the other UE is configured to concurrently monitor, or a combination thereof.

In a forty-ninth aspect, in combination with one or more of the first aspect through the forty-eighth aspect, the techniques further include transmitting one or more SCI associated with multiple Tx-SL.

In a fiftieth aspect, in combination with the forty-ninth aspect, the one or more SCI include, for each Tx-SL of the multiple Tx-SL, an SCI that indicates a resource allocated for the Tx-SL.

In a fifty-first aspect, in combination with the forty-ninth aspect, the one or more SCI include a single SCI that indicates, for each Rx UE associated with the SL communication, a FDRA of a Tx-SL resource set of the Rx UE.

In a fifty-second aspect, in combination with one or more of the first aspect through the fifty-first aspect, an RSRP threshold is based on half-duplex communication or full-duplex communication on the SL, half-duplex communication or full-duplex communication on the Uu link, or a combination thereof

In a fifty-third aspect, in combination with the fifty-second aspect, the techniques further include transmitting RSRP information that indicates the RSRP threshold.

In a fifty-fourth aspect, in combination with the fifty-second aspect, the techniques further include receiving, from a base station, RSRP information that indicates the RSRP threshold.

In a fifty-fifth aspect, in combination with the fifty-fourth aspect, the techniques further include receiving, from the base station, a grant on the Uu link, the grant includes the RSRP information.

In a fifty-sixth aspect, in combination with the fifty-second aspect, the techniques further include adjusting the RSRP threshold.

In a fifty-seventh aspect, in combination with the fifty-sixth aspect, the RSRP threshold is adjusted based on an agreement with another UE associated with the SL communication or a base station.

In a fifty-eighth aspect, in combination with the fifty-sixth aspect or the fifty-seventh aspect, the RSRP threshold is adjusted based on a scheduled grant or configured grant of the Uu link.

In a fifty-ninth aspect, in combination with one or more of the fifty-sixth aspect through the fifty-eighth aspect, the RSRP threshold is adjusted based on a grant associated with the Uu link and that is known to the UE.

In a sixtieth aspect, in combination with one or more of the fifty-sixth aspect through the fifty-ninth aspect, the RSRP threshold is adjusted based on the Uu communication being half-duplex or full-duplex.

In a sixty-first aspect, in combination with one or more of the first aspect through the sixtieth aspect, the techniques further include adjusting a channel sensing parameter based on a full-duplex status of the SL communication, a full-duplex status of the Uu communication, or a combination thereof.

In a sixty-second aspect, in combination with the sixty-first aspect, the channel sensing parameter include a first sensing window parameter (T₀), a second sensing window parameter (T_{2,min}), or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-16 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication performed by a user equipment (UE), the method comprising:
based on self-interference being greater than or equal to a threshold during sidelink (SL) communication and air interface (Uu) communication:
performing an interference cancellation operation on one of a SL of the SL communication or a Uu link of the Uu communication; and
dropping the other of the SL or the Uu link.

2. The method of claim 1, further comprising:
configuring the UE for concurrent full duplex SL communication and full duplex Uu communication;
detecting self-interference greater than or equal to a threshold during full duplex SL communication and full duplex Uu communication; and
selecting the one of the SL or the Uu link for the interference cancellation operation,
wherein the one of the SL or the Uu link is selected based on one or more parameters, the one or more parameters include:
a priority of traffic communicated via the SL, a priority of traffic communicated via the Uu link, or a combination thereof;
a gap between a downlink band and an uplink band associated with the Uu communication, a gap between a transmit (Tx) subband and a receive (Rx) subband associated with the SL communication, or a gap between a Tx sub-resource pool and an Rx sub-resource pool associated with the SL communication;
a transmit power for the SL communication, a transmit power for the Uu communication, or a combination thereof; or
a resource allocation (RA) mode.

3. The method of claim 2, wherein:
the one or more parameters further include:
a quality of service of traffic communicated via the SL, a quality of service of traffic communicated via the Uu link, or a combination thereof;
a number of full-duplex sub-slots in a SL slot, a number of half-duplex sub-slots in the SL slot, or a combination thereof;
a mode of operation of the UE;
a remaining packet delay budge (PDB); or
a combination thereof; and
dropping the SL link includes droppings a Tx SL, an Rx SL, or both; or
dropping the Uu link includes dropped an uplink (UL), a downlink (DL), or both.

4. The method of claim 1, further comprising:
transmitting UE capability information that indicates that the UE supports full-duplex operation; and
receiving, from a base station, resource pool information that indicates a resource pool for the SL communication during sub-band full duplex (SBFD) operation or in-band full duplex (IBFD) operation, the resource pool includes a maximum power constraint on a UE, and
wherein the base station allocates the resource pool for use by the UE based on the UE supporting full-duplex operation, or
wherein the resource pool is configured for mode 1 resource allocation (RA).

5. The method of claim 1, wherein:
the SL communication includes a mini-slot format,
a slot communication direction is defined by the UE or a base station, and
the slot communication direction includes transmit (Tx) only, receive (Rx) only, or full-duplex.

6. The method of claim 5, further comprising:
receiving, from a base station, slot direction information for one or more sub-slots of a slot for the SL communication, the slot direction information indicates half-duplex communication or full-duplex communication; and
transmitting SL control information (SCI) to another UE, the SCI indicates the slot direction information for SL communication between the UE and the other UE.

7. The method of claim 5, further comprising:
determining slot direction information for one or more sub-slots of a slot for the SL communication between the UE and another UE, and
the slot direction information determined based on:
a remaining packet delay budge (PDB); or
a priority of traffic to be transmitted by the UE via the SL, a priority of traffic to be transmitted by the other UE via the Uu link, or a combination thereof.

8. The method of claim 1, further comprising:
generating SL control information (SCI) that indicates, for a slot for SL communication between the UE and another UE, a first set of sub-slots for transmission by the UE, a second set of sub-slots for transmission by the other UE, a third set of sub-slots for full-duplex transmission, or a combination thereof; and
transmitting the SCI to another UE.

9. The method of claim 1, further comprising:
receiving, from a base station, a change indicator that indicates to change a time division duplex (TDD) pattern from a first TDD to a second TDD for use during the Uu communication, the SL communication, or both, and
wherein the first TDD includes a dedicated TTD pattern or a common TDD patterns.

10. The method of claim 1, further comprising:
receiving a per sub-band dedicated time division duplex (TDD) pattern, the per sub-band dedicated TDD pattern is configured such that a first sub-band that overlaps with the SL has more uplink (UL) slots than a second sub-band that does not overlap with the SL.

11. The method of claim 1, further comprising:
receiving, from a base station, a SL grant, and
wherein, for the UE configured for a mode 1 resource allocation (RA), the SL grant includes:
one or more configured grants (CGs) associated with one or more receive (Rx) UEs; or
one or more dynamic grants (DGs) associated with the one or more Rx UEs.

12. The method of claim 11, further comprising:
transmitting, to the base station, SL information that indicates:
a time division duplex (TDD) pattern for the SL communication;
usage of a resource pool;
a gap between a transmit (Tx) resource and a receive (Rx) resource;
for the SL communication between the UE and another UE:
a first number of Rx resources that the UE is configured to concurrently monitor; or
a second number of Rx resources that the other UE is configured to concurrently monitor; or
a combination thereof.

13. The method of claim 1, further comprising:
transmitting one or more SL control information (SCI) associated with multiple transmit (Tx)-SLs, and
wherein, the one or more SCI include:
for each Tx-SL of the multiple Tx-SLs, an SCI of the one or more SCI that indicates a resource allocated for the Tx-SL; or
a single SCI that indicates, for each receive (Rx) UE associated with the SL communication, a frequency domain resource allocation (FDRA) of a Tx-SL resource set of the Rx UE.

14. The method of claim 1, further comprising:
determining a reference signal received power (RSRP) threshold, the RSRP threshold is based on half-duplex communication or full-duplex communication on the SL, half-duplex communication or full-duplex communication on the Uu link, or a combination thereof; and
transmitting RSRP information that indicates the RSRP threshold; or
receiving, from a base station, the RSRP information that indicates the RSRP threshold.

15. The method of claim 14, further comprising:
adjusting the RSRP threshold based on:
an agreement with another UE associated with the SL communication or a base station;
a scheduled grant or configured grant of the Uu link;
a grant associated with the Uu link and that is known to the UE;
the Uu communication being half-duplex or full-duplex; or
a combination thereof; and
adjusting a channel sensing parameter based on a full-duplex status of the SL communication, a full-duplex status of the Uu communication, or a combination thereof, the channel sensing parameter includes a first sensing window parameter (T₀) a second sensing window parameter (T_{2,min}), or a combination thereof.

16. A user equipment (UE) comprising:
a memory storing processor-readable code; and
at least one processor coupled to the memory, the at least one processor configured to execute the processor-readable code to cause the at least one processor to, based on self-interference being greater than or equal to a threshold during sidelink (SL) communication and air interface (Uu) communication:
perform an interference cancellation operation on one of a SL of the SL communication or a Uu link of the Uu communication; and
drop the other of the SL or the Uu link.

17. The UE of claim 16, wherein the at least one processor is configured to execute the processor-readable code to cause the at least one processor to:
configure the UE for concurrent full duplex SL communication and full duplex Uu communication;
detect self-interference greater than or equal to a threshold during full duplex SL communication and full duplex Uu communication; and
select the one of the SL or the Uu link for the interference cancellation operation,
wherein the one of the SL or the Uu link is selected based on one or more parameters, the one or more parameters include:
a priority of traffic communicated via the SL, a priority of traffic communicated via the Uu link, or a combination thereof;
a gap between a downlink band and an uplink band associated with the Uu communication, a gap between a transmit (Tx) subband and a receive (Rx) subband associated with the SL communication, or a gap between a Tx sub-resource pool and an Rx sub-resource pool associated with the SL communication;
a transmit power for the SL communication, a transmit power for the Uu communication, or a combination thereof; or
a resource allocation (RA) mode.

18. The UE of claim 17, wherein:
the one or more parameters further include:
a quality of service of traffic communicated via the SL, a quality of service of traffic communicated via the Uu link, or a combination thereof;
a number of full-duplex sub-slots in a SL slot, a number of half-duplex sub-slots in the SL slot, or a combination thereof;
a mode of operation of the UE;
a remaining packet delay budge (PDB); or
a combination thereof; and
to drop the SL link, the at least one processor is configured to execute the processor-readable code to cause the at least one processor to drop a Tx SL, an Rx SL, or both; or
to drop the Uu link, the at least one processor is configured to execute the processor-readable code to cause the at least one processor to drop an uplink (UL), a downlink (DL), or both.

19. The UE of claim 16, wherein the at least one processor is configured to execute the processor-readable code to cause the at least one processor to:
transmit UE capability information that indicates that the UE supports full-duplex operation; and
receive, from a base station, resource pool information that indicates a resource pool for the SL communication during sub-band full duplex (SBFD) operation or in-band full duplex (IBFD) operation, the resource pool includes a maximum power constraint on a UE, and
wherein the base station allocates the resource pool for use by the UE based on the UE supporting full-duplex operation, or
wherein the resource pool is configured for mode 1 resource allocation (RA).

20. The UE of claim 16, wherein:
the SL communication includes a mini-slot format,
a slot communication direction is defined by the UE or a base station, and
the slot communication direction includes transmit (Tx) only, receive (Rx) only, or full-duplex.

21. The UE of claim 20, wherein the at least one processor is configured to execute the processor-readable code to cause the at least one processor to:
receive, from a base station, slot direction information for one or more sub-slots of a slot for the SL communication, the slot direction information indicates half-duplex communication or full-duplex communication; and
transmit SL control information (SCI) to another UE, the SCI indicates the slot direction information for SL communication between the UE and the other UE.

22. The UE of claim 20, wherein the at least one processor is configured to execute the processor-readable code to cause the at least one processor to:
determine slot direction information for one or more sub-slots of a slot for the SL communication between the UE and another UE, and
the slot direction information determined based on:
a remaining packet delay budge (PDB); or
a priority of traffic to be transmitted by the UE via the SL, a priority of traffic to be transmitted by the other UE via the Uu link, or a combination thereof.

23. The UE of claim 16, wherein the at least one processor is configured to execute the processor-readable code to cause the at least one processor to:
generate SL control information (SCI) that indicates, for a slot for SL communication between the UE and another UE, a first set of sub-slots for transmission by the UE, a second set of sub-slots for transmission by the other UE, a third set of sub-slots for full-duplex transmission, or a combination thereof; and
transmit the SCI to another UE.

24. The UE of claim 16, wherein the at least one processor is configured to execute the processor-readable code to cause the at least one processor to:
receive, from a base station, a change indicator that indicates to change a time division duplex (TDD) pattern from a first TDD to a second TDD for use during the Uu communication, the SL communication, or both, and
wherein the first TDD includes a dedicated TTD pattern or a common TDD patterns.

25. The UE of claim 16, wherein the at least one processor is configured to execute the processor-readable code to cause the at least one processor to:
receive a per sub-band dedicated time division duplex (TDD) pattern, the per sub-band dedicated TDD pattern is configured such that a first sub-band that overlaps with the SL has more uplink (UL) slots than a second sub-band that does not overlap with the SL.

26. The UE of claim 16, wherein the at least one processor is configured to execute the processor-readable code to cause the at least one processor to:
receive, from a base station, an SL grant, and
wherein, for the UE configured for a mode 1 resource allocation (RA), the SL grant includes:
one or more configured grants (CGs) associated with one or more receive (Rx) UEs; or
one or more dynamic grants (DGs) associated with the one or more Rx UEs.

27. The UE of claim 26, wherein the at least one processor is configured to execute the processor-readable code to cause the at least one processor to:
transmit, to the base station, SL information that indicates:
a time division duplex (TDD) pattern for the SL communication;
usage of a resource pool;
a gap between a transmit (Tx) resource and a receive (Rx) resource;
for the SL communication between the UE and another UE:
a first number of Rx resources that the UE is configured to concurrently monitor; or
a second number of Rx resources that the other UE is configured to concurrently monitor; or
a combination thereof.

28. The UE of claim 16, wherein the at least one processor is configured to execute the processor-readable code to cause the at least one processor to:
transmit one or more SL control information (SCI) associated with multiple transmit (Tx)-SLs, and
wherein, the one or more SCI include:
for each Tx-SL of the multiple Tx-SLs, an SCI of the one or more SCI that indicates a resource allocated for the Tx-SL; or
a single SCI that indicates, for each receive (Rx) UE associated with the SL communication, a frequency domain resource allocation (FDRA) of a Tx-SL resource set of the Rx UE.

29. The UE of claim 16, wherein the at least one processor is configured to execute the processor-readable code to cause the at least one processor to:
determine a reference signal received power (RSRP) threshold, the RSRP threshold is based on half-duplex communication or full-duplex communication on the SL, half-duplex communication or full-duplex communication on the Uu link, or a combination thereof; and
transmit RSRP information that indicates the RSRP threshold; or
receive, from a base station, the RSRP information that indicates the RSRP threshold.

30. The UE of claim 29, wherein the at least one processor is configured to execute the processor-readable code to cause the at least one processor to:
adjust the RSRP threshold based on:
an agreement with another UE associated with the SL communication or a base station;
a scheduled grant or configured grant of the Uu link;
a grant associated with the Uu link and that is known to the UE;
the Uu communication being half-duplex or full-duplex; or
a combination thereof; and
adjust a channel sensing parameter based on a full-duplex status of the SL communication, a full-duplex status of the Uu communication, or a combination thereof, the channel sensing parameter includes a first sensing window parameter (T₀), a second sensing window parameter (T_{2,min}) or a combination thereof.
